(19) United States
(12) Patent Application Publication
(10) Pub. No.: US 2014/0238363 A1
(43) Pub. Date: Aug. 28, 2014

(54) EXHAUST GAS RECIRCULATION SYSTEM

(71) Applicant: GM GLOBAL TECHNOLOGY OPERATIONS LLC, Detroit, MI (US)

(72) Inventors: Edward J. Keating, Ortonville, MI (US); Alan W. Hayman, Romeo, MI (US)

(73) Assignee: GM GLOBAL TECHNOLOGY OPERATIONS LLC, Detroit, MI (US)

(21) Appl. No.: 13/776,770

(22) Filed: Feb. 26, 2013

(51) Int. Cl. F02M 25/07

(52) U.S. Cl. CPC F02M 25/077
USPC 123/568.17

(57) ABSTRACT

An exhaust gas recirculation system includes an engine defining first and second combustion chambers, wherein a fuel is combustible to produce a combustion gas. The system includes an intake manifold disposed in fluid communication with the first and second chambers, an exhaust manifold disposed in fluid communication with the second chamber, and an exhaust gas recirculation conduit disposed in fluid communication with the first chamber and configured for directing the gas from only the first chamber to the intake manifold. The system includes a bypass valve transitionable between a first position wherein the conduit is disposed in fluid communication with the exhaust manifold such that the gas flows from the first chamber to the exhaust manifold, and a second position wherein the conduit is not disposed in fluid communication with the exhaust manifold such that the gas does not flow from the first chamber to the exhaust manifold.

### TECHNICAL FIELD

The present disclosure relates to exhaust gas recirculation systems.

### BACKGROUND

Internal combustion engines may combust a mixture of air and fuel within one or more combustion chambers and thereby produce exhaust gases. Some internal combustion engines may include an exhaust gas recirculation system configured for recirculating a portion of the exhaust gases within the internal combustion engine to allow for improved efficiency and reduced emissions.

### SUMMARY

An exhaust gas recirculation system includes an internal combustion engine defining a first combustion chamber and a second combustion chamber, wherein a fuel is combustible within the first combustion chamber and the second combustion chamber to produce a combustion gas. The exhaust gas recirculation system also includes an intake manifold disposed in fluid communication with the first combustion chamber and the second combustion chamber and configured for directing air to the first combustion chamber and the second combustion chamber. Further, the exhaust gas recirculation system includes an exhaust manifold disposed in fluid communication with the second combustion chamber and configured for removing the combustion gas from the internal combustion engine. In addition, the exhaust gas recirculation system includes an exhaust gas recirculation conduit disposed in fluid communication with the first combustion chamber and configured for directing the combustion gas from only the first combustion chamber to the intake manifold. The exhaust gas recirculation system also includes a bypass valve transitionable between a first position wherein the exhaust gas recirculation conduit is disposed in fluid communication with the exhaust manifold such that the combustion gas flows from the first combustion chamber to the exhaust manifold, and a second position wherein the exhaust gas recirculation conduit is not disposed in fluid communication with the exhaust manifold such that the combustion gas does not flow from the first combustion chamber to the exhaust manifold.

In one embodiment, the internal combustion engine defines a first combustion chamber and at least a second combustion chamber, and includes an intake manifold disposed in fluid communication with the first combustion chamber and the at least second combustion chamber and configured for directing air to the first combustion chamber and the at least second combustion chamber. Further, the exhaust gas recirculation system includes an exhaust manifold disposed in fluid communication with the at least second combustion chamber and configured for directing the combustion gas from the internal combustion engine. The exhaust gas recirculation system also includes an exhaust gas recirculation conduit disposed in fluid communication with the first combustion chamber and configured for directing the combustion gas from only the first combustion chamber to the intake manifold. In addition, the exhaust gas recirculation system includes a bypass valve transitionable between a first position wherein the exhaust gas recirculation conduit is disposed in fluid communication with the exhaust manifold such that the combustion gas flows from the first combustion chamber to the exhaust manifold, and a second position wherein the exhaust gas recirculation conduit is not disposed in fluid communication with the exhaust manifold such that the combustion gas does not flow from the first combustion chamber to the exhaust manifold. The internal combustion engine is operable during a first load condition wherein the internal combustion engine produces a first torque under a first load, and is operable during a second load condition wherein the internal combustion engine produces a second torque under a second load, wherein the first load is greater than the second load. Further, the bypass valve is disposed in the first position during the first load condition and is disposed in the second position during the second load condition.

In another embodiment, the internal combustion engine defines a first combustion chamber and at least a second combustion chamber, and includes an intake manifold disposed in fluid communication with the first combustion chamber and the at least second combustion chamber and configured for directing air to the first combustion chamber and the at least second combustion chamber. Further, the exhaust gas recirculation system includes an exhaust manifold disposed in fluid communication with the at least second combustion chamber and configured for directing the combustion gas from the internal combustion engine. The exhaust gas recirculation system also includes an exhaust gas recirculation conduit disposed in fluid communication with the first combustion chamber and configured for directing the combustion gas from only the first combustion chamber to the intake manifold. In addition, the exhaust gas recirculation system includes a bypass valve transitionable between a first position wherein the exhaust gas recirculation conduit is disposed in fluid communication with the exhaust manifold such that the combustion gas flows from the first combustion chamber to the exhaust manifold, and a second position wherein the exhaust gas recirculation conduit is not disposed in fluid communication with the exhaust manifold such that the combustion gas does not flow from the first combustion chamber to the exhaust manifold. The exhaust gas recirculation system also includes an intake valve and an exhaust valve. The intake valve is configured for sealing the first combustion chamber from the intake manifold and is transitionable between an open position in which the intake manifold is not sealed off from the first combustion chamber, and a closed position in which the intake manifold is sealed off from the first combustion chamber. The exhaust valve is configured for sealing the combustion gas with the first combustion chamber and is transitionable between an unseated position in which the exhaust valve does not seal the combustion gas within the first combustion chamber, and a seated position in which the exhaust valve seals the combustion gas within the first combustion chamber. Moreover, the intake valve is disposed in the open position and the exhaust valve is concurrently disposed in the unseated position during the first load condition.

The above features and advantages and other features and advantages of the present invention will be readily apparent from the following detailed description of the preferred embodiments and best modes for carrying out the present invention when taken in connection with the accompanying drawings and appended claims.

### BRIEF DESCRIPTION OF THE DRAWINGS

FIG. 1 is a schematic illustration of a plan view of an exhaust gas recirculation system including an internal combustion engine defining a first combustion chamber and operable at a first load condition;

FIG. 2 is a schematic illustration of a plan view of the exhaust gas recirculation system of FIG. 1, wherein the internal combustion engine is operable at a second load condition; and

FIG. 3 is a schematic illustration of a cross-sectional view of the first combustion chamber of FIGS. 1 and 2, wherein the exhaust gas recirculation system includes an intake valve disposed in an open position and an exhaust valve concurrently disposed in an unseated position.

### DETAILED DESCRIPTION

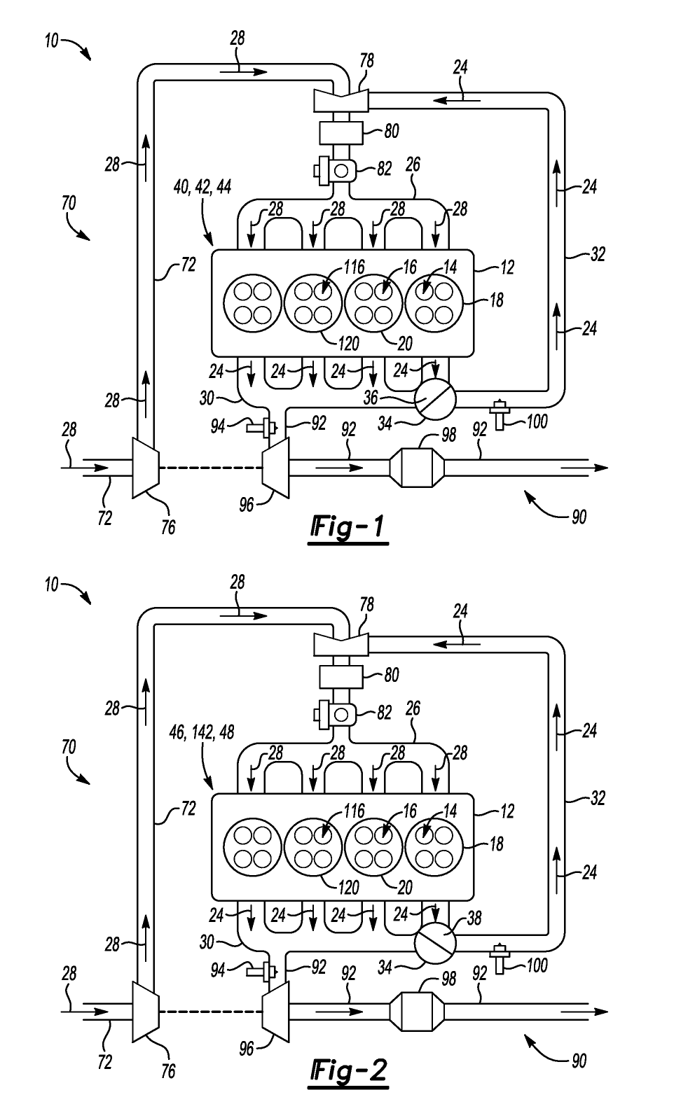

Referring to the Figures, wherein like reference numerals refer to like elements, an exhaust gas recirculation system 10 is shown generally in FIG. 1. The exhaust gas recirculation system 10 may be useful for vehicles, such as automotive vehicles, that require an internal combustion engine 12 having excellent efficiency. As such, the exhaust gas recirculation system 10 may also be useful for non-automotive applications including, for example, recreational vehicle applications.

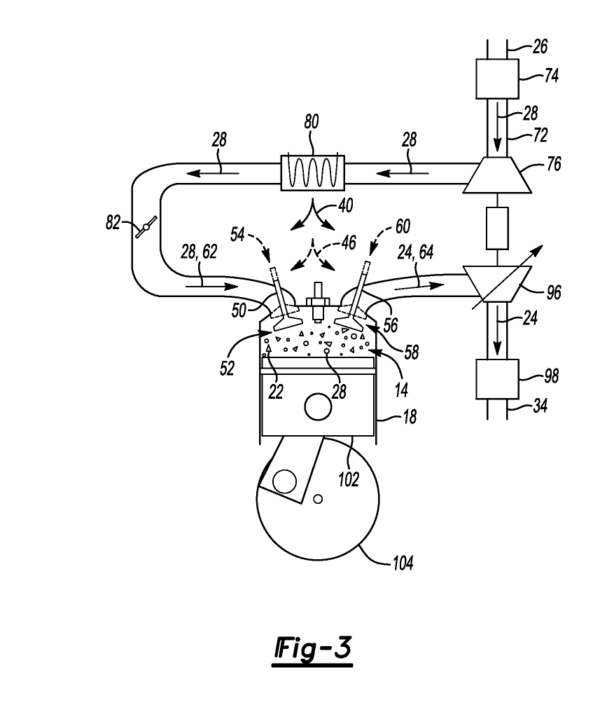

Referring to FIG. 1, the exhaust gas recirculation system 10 includes an internal combustion engine 12 defining a first combustion chamber 14 and a second combustion chamber 16. That is, the internal combustion engine 12 may be characterized as a multi-cylinder engine, and may include a first cylinder 18 defining the first combustion chamber 14 and at least a second cylinder 20, 120 defining at least the second combustion chamber 16, 116. For example, the internal combustion engine 12 may be a 2-cylinder, 3-cylinder, 4-cylinder, 6-cylinder, 8-cylinder, or 12-cylinder engine. During operation, a mixture of a fuel (shown generally at 22 in FIG. 3) and air (shown generally at 28 in FIG. 3) may combust within the first combustion chamber 14 and the at least second combustion chamber 16, 116 to effect linear translation of a piston (shown generally at 102 in FIG. 3) and rotation of a crankshaft (shown generally at 104 in FIG. 3) to thereby produce torque. More specifically, the fuel 22 is combustible within the first combustion chamber 14 and the second combustion chamber 16 to produce a combustion gas (represented generally at 24), i.e., an exhaust gas. The fuel 22 may be any suitable combustible material, such as, but not limited to, gasoline and diesel. That is, the internal combustion engine 12 may be a spark-ignited or diesel engine.

With continued reference to FIG. 1, the exhaust gas recirculation system 10 also includes an intake manifold 26 disposed in fluid communication with the first combustion chamber 14 and the second combustion chamber 16. The intake manifold 26 is configured for directing air (represented generally by 28) to the first combustion chamber 14 and the second combustion chamber 16 during operation of the internal combustion engine 12. That is, the intake manifold 26 may be arranged as a plenum to feed air 28 to the internal combustion engine 12. The intake manifold 26 may be fed by an intake system (shown generally at 70 in FIG. 1), which may include one or more inlet conduits 72, air filters 74 (FIG. 3), compressors 76, mixers 78, charge air coolers 80, and/or throttle valves 82.

In addition, as also shown in FIG. 1, the exhaust gas recirculation system 10 includes an exhaust manifold 30 disposed in fluid communication with the second combustion chamber 16. For embodiments including the first combustion chamber 14 and at least the second combustion chamber 16, 116, i.e., three or more combustion chambers 14, 16, 116, the exhaust manifold 30 is disposed in fluid communication with the at least second combustion chamber 16, 116, e.g., the second combustion chamber 16 and a third combustion chamber 116. The exhaust manifold 30 is configured for removing the combustion gas 24 from the internal combustion engine 12. That is, the exhaust manifold 30 may be arranged as a plenum for removing combustion byproducts, i.e., the combustion gas 24, from the at least second combustion chamber 16, 116 during operation of the internal combustion engine 12. The exhaust manifold 30 may feed an exhaust system (shown generally at 90 in FIG. 1), which may include one or more exhaust conduits 92, heated exhaust gas oxygen (HEGO) sensors 94, turbines 96, and/or catalysts 98.

Referring again to FIG. 1, the exhaust gas recirculation system 10 further includes an exhaust gas recirculation conduit 32 disposed in fluid communication with the first combustion chamber 14, and configured for directing the combustion gas 24 from only the first combustion chamber 14 to the intake manifold 26. That is, the exhaust gas recirculation conduit 32 may be a dedicated exhaust gas recirculation (d-EGR) conduit. Stated differently, the exhaust gas recirculation conduit 32 may connect only the first combustion chamber 14, and not the at least second combustion chamber 16, 116, to the intake manifold 26. That is, the exhaust gas recirculation conduit 32 may be dedicated to the first combustion chamber 14. As such, the exhaust gas recirculation system 10 may exclusively route the combustion gas 24 produced within the first combustion chamber 14 to the intake manifold 26.

More specifically, as described with continued reference to FIG. 1, the exhaust gas recirculation conduit 32 may route the combustion gas 24 produced within the first combustion chamber 14 during operation of the internal combustion engine 12 back to the intake manifold 26 so that the combustion gas 24 may mix with fresh air 28 before being re-combusted in the first combustion chamber 14 and the at least second combustion chamber 16, 116. Stated differently, the exhaust gas recirculation conduit 32 may recirculate the combustion gas 24 produced within the first combustion chamber 14 to the intake manifold 26. Further, a universal exhaust gas oxygen sensor (UEGO) (shown generally at 100) may be disposed within the exhaust gas recirculation conduit 32 and may be configured for measuring a proportion of oxygen in the combustion gas 24. Such recirculation of the combustion gas 24 and subsequent mixing of the combustion gas 24 with fresh air 28 in the intake manifold 26 may cool the combustion process, and minimize nitric oxide, NO, and nitrogen dioxide, NO₂, collectively referenced as NOₓ emissions. More specifically, the recirculated combustion gas 24 may absorb heat, diffuse oxygen present in the first and at least second combustion chambers 14, 16, 116 and reduce an amount of air 28 breathed by the internal combustion engine 12 during operation. As set forth in more detail below, such advantages may contribute to increased efficiency of the internal combustion engine 12 during certain operating conditions.

Referring again to FIG. 1, the exhaust gas recirculation system 10 also includes a bypass valve 34. The bypass valve 34 may be disposed within the exhaust gas recirculation conduit 32, e.g., between the first combustion chamber 14 and the intake manifold 26. The bypass valve 34 is transitionable between a first position (indicated generally at 36) wherein the exhaust gas recirculation conduit 32 is disposed in fluid communication with the exhaust manifold 30 such that the combustion gas 24 flows from the first combustion chamber 14 to the exhaust manifold 30, and a second position (indicated generally at 38 in FIG. 2) wherein the exhaust gas recirculation conduit 32 is not disposed in fluid communication with the exhaust manifold 30 such that the combustion gas 24 does not flow from the first combustion chamber 14 to the exhaust manifold 30. For example, the bypass valve 34 may be a two-position valve.

That is, with continued reference to FIG. 1, the first combustion chamber 14 may be sealed off from the exhaust gas recirculation conduit 32 so that the combustion gas 24 may not flow from the first combustion chamber 14 to the intake manifold 26 when the bypass valve 34 is disposed in the first position 36. Stated differently, the exhaust manifold 30 may be sealed off from the exhaust gas recirculation conduit 32 when the bypass valve 34 is disposed in the first position 36 or the second position 38 (FIG. 2) so that the combustion gas 24 may not flow from the exhaust manifold 30 to the exhaust gas recirculation conduit 32 through the bypass valve 34. Conversely, as shown in FIG. 2, the combustion gas 24 may flow from the first combustion chamber 14 to the intake manifold 26 when the bypass valve 34 is disposed in the second position 38. As such, the bypass valve 34 allows the internal combustion engine 12 to bypass the exhaust gas recirculation conduit 32 so that the combustion gas 24 produced within the first combustion chamber 14 is not recirculated to the intake manifold 26 when the bypass valve 34 is disposed in the first position 36.

Furthermore, the internal combustion engine 12 may be operable at a first load condition (indicated generally at 40 in FIG. 1) in which the internal combustion engine 12 produces a first torque 42 under a first load 44, and may be operable at a second load condition (indicated generally at 46 in FIG. 2) in which the internal combustion engine 12 produces a second torque 142 under a second load 48, wherein the first load 44 is greater than the second load 48. That is, the first load condition 40 (FIG. 1) may correspond to a comparatively high-load operating condition of the internal combustion engine 12. By comparison, the second load condition 46 (FIG. 2) may correspond to a comparatively low-load operating condition of the internal combustion engine 12. As used herein, the terminology “load” refers to a measurement of how hard the internal combustion engine 12 is working, and is generally measured as a percentage of available torque output.

Referring again to FIG. 1, during operation of the internal combustion engine 12, the bypass valve 34 may be disposed in the first position 36 during the first load condition 40. That is, the first combustion chamber 14 may be sealed off from the exhaust gas recirculation conduit 32 so that the combustion gas 24 may not flow from the first combustion chamber 14 to the intake manifold 26 during the first load condition 40. Stated differently, during a comparatively high-load operating condition, i.e., the first load condition 40, the combustion gas 24 may bypass the exhaust gas recirculation conduit 32 and instead flow directly from the first combustion chamber 14 to the exhaust manifold 30. In other words, the dedicated exhaust gas recirculation system provided by the exhaust gas recirculation conduit 32 may be disabled during the first load condition 40.

Recirculating the combustion gas 24 produced within the first combustion chamber 14 through the exhaust gas recirculation conduit 32 during the first load condition 40 may decrease the power produced by the internal combustion engine 12. However, the exhaust gas recirculation system 10 may compensate for such power losses of the internal combustion engine 12 when the internal combustion engine 12 operates at comparatively high-load conditions, e.g., at full load, as set forth in more detail below.

Conversely, as described with reference to FIG. 2, during operation of the internal combustion engine 12, the bypass valve 34 may be disposed in the second position 38 during the second load condition 46. That is, the first combustion chamber 14 may be disposed in fluid communication with the exhaust gas recirculation conduit 32 so that the combustion gas 24 may flow from the first combustion chamber 14 to the intake manifold 26 during the second load condition 46. Stated differently, during a comparatively low-load operating condition, i.e., the second load condition 46, the combustion gas 24 may circulate through the exhaust gas recirculation conduit 32 and flow directly from the first combustion chamber 14 to the intake manifold 26. In other words, the dedicated exhaust gas recirculation system provided by the exhaust gas recirculation conduit 32 may be enabled during the second load condition 46.

Therefore, with continued reference to FIG. 2, during the second load condition 46, the exhaust gas recirculation conduit 32 may recirculate the combustion gas 24 produced within the first combustion chamber 14 to the intake manifold 26. Such recirculation of the combustion gas 24 and subsequent mixing of the combustion gas 24 with fresh air 28 in the intake manifold 26 may cool the combustion process, and minimize nitric oxide, NO, and nitrogen dioxide, NO₂, collectively referenced as NOₓ, emissions, during the second load condition 46. More specifically, the recirculated combustion gas 24 may absorb heat, diffuse oxygen present in the first and at least second combustion chambers 14, 16, 116 and reduce an amount of air 28 breathed by the internal combustion engine 12 during operation at the second load condition 46. Therefore, the exhaust gas recirculation system 10 may contribute to increased efficiency of the internal combustion engine 12 during the second load condition 46.

Referring now to FIG. 3, the exhaust gas recirculation system 10 may further include an intake valve 50 configured for sealing the first combustion chamber 14 from the intake manifold 26. The intake valve 50 may be transitionable between an open position 52 in which the intake manifold 26 is not sealed off from the first combustion chamber 14, and a closed position 54 in which the intake manifold 26 is sealed off from the first combustion chamber 14. Therefore, air 28 may flow from the intake manifold 26 to the first combustion chamber 14 when the intake valve 50 is disposed in the open position 52, and may not flow from the intake manifold 26 to the first combustion chamber 14 when the intake valve 50 is disposed in the closed position 54. In addition, although not shown, the exhaust gas recirculation system 10 may further include a plurality of intake valves 50 per each respective combustion chamber 14, 16, 116.

Further, with continued reference to FIG. 3, the exhaust gas recirculation system 10 may also include an exhaust valve 56 configured for sealing the combustion gas 24 within the first combustion chamber 14. The exhaust valve 56 may be transitionable between an unseated position 58 in which the exhaust valve 56 does not seal the combustion gas 24 within the first combustion chamber 14, and a seated position 60 in which the exhaust valve 56 seals the combustion gas 24 within the first combustion chamber 14. Therefore, the combustion gas 24 may flow from the first combustion chamber 14 to the bypass valve 34 when the exhaust valve 56 is disposed in the unseated position 58, and may not flow from the first combustion chamber 14 to the bypass valve 34 when the exhaust valve 56 is disposed in the seated position 60. In addition, although not shown, the exhaust gas recirculation system 10 may further include a plurality of exhaust valves 56 per each respective combustion chamber 14, 16, 116.

Referring again to FIG. 3, the intake valve 50 may be disposed in the open position 52 and the exhaust valve 56 may be concurrently disposed in the unseated position 58 during the first load condition 40. That is, during the first load condition 40, i.e., a comparatively high-load operating condition of the internal combustion engine 12 (FIG. 1), each of the intake valve 50 and the exhaust valve 56 may be partially “open”, i.e., at least partially unseated from the first cylinder 18 and the at least second cylinder 20, 120, at the same time to allow for scavenging or removal of the combustion gas 24 from the first combustion chamber 14 and the at least second combustion chamber 16, 116 when the bypass valve 34 is disposed in the first position 36 (FIG. 1). Such conditions may also be described as intake and exhaust valve overlap, and may be controlled by an engine control unit (not shown) of the vehicle. Further, such scavenging or removal of the combustion gas 24 from the first combustion chamber 14 and the at least second combustion chamber 16, 116, allows the internal combustion engine 12 to operate at a comparatively higher compression ratio than would be possible otherwise, i.e., without such scavenging or removal of the combustion gas 24. Comparatively higher compression ratios may also contribute to improved fuel economy for the internal combustion engine 12 during high-load conditions, i.e., during operation at the first load condition 40. The comparatively higher compression ratio provided by the exhaust gas recirculation system 10 during the first load condition 40 may be achieved without the aforementioned power loss that otherwise may result if the comparatively higher compression ratio is achieved by dedicated exhaust gas recirculation, e.g., through the exhaust gas recirculation conduit 32, at the first load condition 40.

More specifically, a first air pressure (denoted generally by 62 in FIG. 3) at the intake valve 50 may be greater than a second air pressure (denoted generally by 64 in FIG. 3) at the exhaust valve 56 such that the combustion gas 24 flows from the first combustion chamber 14 to the bypass valve 34 during the first load condition 40. For example, for internal combustion engines 12 including a turbocharger (not shown), the first air pressure 62 at the intake manifold 26 and intake valve 50 may be greater than the second air pressure 64 at the exhaust valve 56 so that the combustion gas 24 may be scavenged from the first combustion chamber 14 during the first load condition 40. Likewise, for naturally-aspirated internal combustion engines 12 that do not include a turbocharger, but rather include the exhaust manifold 30 (FIG. 1) tuned or configured to provide a positive pressure differential between the intake valve 50 and the exhaust valve 56, the first air pressure 62 at the intake manifold 26 and intake valve 50 may also be greater than the second air pressure 64 at the exhaust valve 56 so that the combustion gas 24 may be scavenged from the first combustion chamber 14 during the first load condition 40.

Therefore, the exhaust gas recirculation system 10 (FIG. 1) allows the internal combustion engine 12 (FIG. 1) to operate at a comparatively higher compression ratio during the first load condition 40 (FIG. 1) by bypassing the exhaust gas recirculation conduit 32 (FIG. 1) and instead relying on the intake valve 50 (FIG. 3) and the exhaust valve 56 (FIG. 3) concurrently disposed in the open position 52 (FIG. 3) and the unseated position 58 (FIG. 3), respectively, to thereby improve efficiency of the internal combustion engine 12. Likewise, the exhaust gas recirculation system 10 also allows the internal combustion engine 12 to operate at the comparatively higher compression ratio during the second load condition 46 (FIG. 2) by routing the combustion gas 24 from the first combustion chamber 14 through the bypass valve 34 and the exhaust gas recirculation conduit 32 to thereby improve efficiency of the internal combustion engine 12.

As such, the exhaust gas recirculation system 10 (FIG. 1) described herein allows for downsizing engine displacement during the first load condition 40 (FIG. 2), and the aforementioned redirection of the combustion gas 24 directly to the exhaust manifold 30 during the first load condition 40 may improve the fuel efficiency of the internal combustion engine 12 due to mitigation of the aforementioned power loss.

Generally, the internal combustion engine 12 may transform comparatively more mechanical energy from a given mass of an air/fuel mixture when the internal combustion engine 12 operates at a comparatively higher compression ratio. The internal combustion engine 12 may operate more efficiently at a comparatively higher compression ratio because the comparatively higher compression ratio permits the same combustion temperature to be reached with less fuel 22 (FIG. 3) than an internal combustion engine 12 which operates at a comparatively lower compression ratio. Likewise, such comparatively higher compression ratios may also permit increased mechanical power output and lower the temperature of the combustion gas 24.

While the best modes for carrying out the present invention have been described in detail, those familiar with the art to which this invention relates will recognize various alternative designs and embodiments for practicing the invention within the scope of the appended claims.

1. An exhaust gas recirculation system comprising:
an internal combustion engine defining a first combustion chamber and a second combustion chamber, wherein a fuel is combustible within the first combustion chamber and the second combustion chamber to produce a combustion gas;
an intake manifold disposed in fluid communication with the first combustion chamber and the second combustion chamber and configured for directing air to the first combustion chamber and the second combustion chamber;
an exhaust manifold disposed in fluid communication with the second combustion chamber and configured for removing the combustion gas from the internal combustion engine;
an exhaust gas recirculation conduit disposed in fluid communication with the first combustion chamber and configured for directing the combustion gas from only the first combustion chamber to the intake manifold; and
a bypass valve transitionable between a first position wherein the exhaust gas recirculation conduit is disposed in fluid communication with the exhaust manifold such that the combustion gas flows from the first combustion chamber to the exhaust manifold, and a second position wherein the exhaust gas recirculation conduit is not disposed in fluid communication with the exhaust manifold such that the combustion gas does not flow from the first combustion chamber to the exhaust manifold.

2. The exhaust gas recirculation system of claim 1, wherein the first combustion chamber is sealed off from the exhaust gas recirculation conduit so that the combustion gas does not flow from the first combustion chamber to the intake manifold when the bypass valve is disposed in the first position.

3. The exhaust gas recirculation system of claim 1, wherein the exhaust manifold is sealed off from the exhaust gas recirculation conduit when the bypass valve is disposed in the first position or the second position so that the combustion gas does not flow from the exhaust manifold to the exhaust gas recirculation conduit through the bypass valve.

4. The exhaust gas recirculation system of claim 1, wherein the internal combustion engine is operable at a first load condition in which the internal combustion engine produces a first torque under a first load, and is operable at a second load condition in which the internal combustion engine produces a second torque under a second load, wherein the first load is greater than the second load.

5. The exhaust gas recirculation system of claim 4, wherein the bypass valve is disposed in the first position during the first load condition.

6. The exhaust gas recirculation system of claim 4, wherein the bypass valve is disposed in the second position during the second load condition.

7. The exhaust gas recirculation system of claim 4, wherein the first combustion chamber is sealed off from the exhaust gas recirculation conduit so that the combustion gas does not flow from the first combustion chamber to the intake manifold during the first load condition.

8. The exhaust gas recirculation system of claim 4, wherein the first combustion chamber is disposed in fluid communication with the exhaust gas recirculation conduit so that the combustion gas flows from the first combustion chamber to the intake manifold during the second load condition.

9. The exhaust gas recirculation system of claim 6, further including:
an intake valve configured for sealing the first combustion chamber from the intake manifold and transitionable between an open position in which the intake manifold is not sealed off from the first combustion chamber, and a closed position in which the intake manifold is sealed off from the first combustion chamber;
wherein air flows from the intake manifold to the first combustion chamber when the intake valve is disposed in the open position, and does not flow from the intake manifold to the first combustion chamber when the intake valve is disposed in the closed position; and
an exhaust valve configured for sealing the combustion gas within the first combustion chamber and transitionable between an unseated position in which the exhaust valve does not seal the combustion gas within the first combustion chamber, and a seated position in which the exhaust valve seals the combustion gas within the first combustion chamber;
wherein the combustion gas flows from the first combustion chamber to the bypass valve when the exhaust valve is disposed in the unseated position, and does not flow from the first combustion chamber to the bypass valve when the exhaust valve is disposed in the seated position.

10. The exhaust gas recirculation system of claim 9, wherein the intake valve is disposed in the open position and the exhaust valve is concurrently disposed in the unseated position during the first load condition.

11. The exhaust gas recirculation system of claim 10, wherein a first air pressure at the intake valve is greater than a second air pressure at the exhaust valve such that the combustion gas flows from the first combustion chamber to the bypass valve.

12. An exhaust gas recirculation system comprising:
an internal combustion engine defining a first combustion chamber and at least a second combustion chamber, wherein a fuel is combustible within the first combustion chamber and the at least second combustion chamber to produce a combustion gas;
an intake manifold disposed in fluid communication with the first combustion chamber and the at least second combustion chamber and configured for directing air to the first combustion chamber and the at least second combustion chamber;
an exhaust manifold disposed in fluid communication with the at least second combustion chamber and configured for removing the combustion gas from the internal combustion engine;
an exhaust gas recirculation conduit disposed in fluid communication with the first combustion chamber and configured for directing the combustion gas from only the first combustion chamber to the intake manifold; and
a bypass valve transitionable between a first position wherein the exhaust gas recirculation conduit is disposed in fluid communication with the exhaust manifold such that the combustion gas flows from the first combustion chamber to the exhaust manifold, and a second position wherein the exhaust gas recirculation conduit is not disposed in fluid communication with the exhaust manifold such that the combustion gas does not flow from the first combustion chamber to the exhaust manifold;
wherein the internal combustion engine is operable during a first load condition in which the internal combustion engine produces a first torque under a first load, and is operable during a second load condition in which the internal combustion engine produces a second torque under a second load, wherein the first load is greater than the second load; and
wherein the bypass valve is disposed in the first position during the first load condition and is disposed in the second position during the second load condition.

13. The exhaust gas recirculation system of claim 12, wherein the first combustion chamber is sealed off from the exhaust gas recirculation conduit so that the combustion gas does not flow from the first combustion chamber to the intake manifold when the bypass valve is disposed in the first position.

14. The exhaust gas recirculation system of claim 12, wherein the exhaust manifold is sealed off from the exhaust gas recirculation conduit when the bypass valve is disposed in the first position or the second position so that the combustion gas does not flow from the exhaust manifold to the exhaust gas recirculation conduit through the bypass valve.

15. The exhaust gas recirculation system of claim 12, wherein the first combustion chamber is sealed off from the exhaust gas recirculation conduit so that the combustion gas does not flow from the first combustion chamber to the intake manifold during the first load condition.

16. The exhaust gas recirculation system of claim 12, wherein the first combustion chamber is disposed in fluid communication with the exhaust gas recirculation conduit so that the combustion gas flows from the first combustion chamber to the intake manifold during the second load condition.

17. An exhaust gas recirculation system comprising:
an internal combustion engine defining a first combustion chamber and at least a second combustion chamber, wherein a fuel is combustible within the first combustion chamber and the at least second combustion chamber to produce a combustion gas;
an intake manifold disposed in fluid communication with the first combustion chamber and the at least second combustion chamber and configured for directing air to the first combustion chamber and the at least second combustion chamber;
an exhaust manifold disposed in fluid communication with the at least second combustion chamber and configured for removing the combustion gas from the internal combustion engine;
an exhaust gas recirculation conduit disposed in fluid communication with the first combustion chamber and configured for directing the combustion gas from only the first combustion chamber to the intake manifold;
a bypass valve transitionable between a first position wherein the exhaust gas recirculation conduit is disposed in fluid communication with the exhaust manifold such that the combustion gas flows from the first combustion chamber to the exhaust manifold, and a second position wherein the exhaust gas recirculation conduit is not disposed in fluid communication with the exhaust manifold such that the combustion gas does not flow from the first combustion chamber to the exhaust manifold;
an intake valve configured for sealing the first combustion chamber from the intake manifold and transitionable between an open position in which the intake manifold is not sealed off from the first combustion chamber, and a closed position in which the intake manifold is sealed off from the first combustion chamber; and
an exhaust valve configured for sealing the combustion gas within the first combustion chamber and transitionable between an unseated position in which the exhaust valve does not seal the combustion gas within the first combustion chamber, and a seated position in which the exhaust valve seals the combustion gas within the first combustion chamber;
wherein the intake valve is disposed in the open position and the exhaust valve is concurrently disposed in the unseated position during the first load condition.

18. The exhaust gas recirculation system of claim 17, wherein the first combustion chamber is sealed off from the exhaust gas recirculation conduit so that the combustion gas does not flow from the first combustion chamber to the intake manifold when the bypass valve is disposed in the first position.

19. The exhaust gas recirculation system of claim 17, wherein the exhaust manifold is sealed off from the exhaust gas recirculation conduit when the bypass valve is disposed in the first position or the second position so that the combustion gas does not flow from the exhaust manifold to the exhaust gas recirculation conduit through the bypass valve.
